(19) United States
(12) Patent Application Publication
(10) Pub. No.: US 2004/0194515 A1
(43) Pub. Date: Oct. 7, 2004

(54) Firearm lock assembly

(76) Inventor: Adam S. Weinraub, Orange, CA (US)

Correspondence Address: Harold L. Jackson, Jackson Law Corporation, 14751 Plaza Dr., Ste. N, Tustin, CA, 92780, US

(21) Appl. No.: 10/796,515

(22) Filed: Mar. 9, 2004

Related U.S. Application Data
(63) Continuation of application No. 10/255,828, filed on Sep. 26, 2002, now Pat. No. 6,725,692.

(51) Int. Cl. E05B 67/06; E05B 65/00

(52) U.S. Cl. 70/49

(57) ABSTRACT

A lock housing for releasably securing the free end of a cable or shackle in the interior of the housing is in the form of an inner substantially rigid non-steel body encapsulated or enclosed within a hardened steel shell. The housing has a top and bottom wall and cable or shackle free end receiving bore. A cavity extends into the housing from the bottom wall with a key lock cylinder mounted therein. The lock cylinder includes a rotatable plug for turning through a predetermined angle from a locked to an unlocked position with a key. A locking member or deadbolt, coupled to the plug, is arranged to move into a detent or groove in the cable or shackle free end to secure the free end in the housing. Rotating the plug to the unlocked position allows the cable of shackle free end to be removed from the housing.

### RELATED APPLICATION

This application is a continuation of U.S. application Ser. No. 10/255,828 filed Sep. 26, 2002 entitled FIREARM LOCK ASSEMBLY.

### FIELD OF THE INVENTION

This invention relates generally to firearm safety lock devices and more particularly to cable type locks arranged to extend through the barrel and/or the cartridge ejection port.

### BACKGROUND OF THE INVENTION

Thousand of handguns, shotguns and rifles are purchased every year by citizens for use in sporting events, such as hunting or trap and skeet shooting, or for use in home protection. Typically, guns are stored at one's home or apartment in drawers, closets or even under the bed. While a minority of gun owners have gun safes to store their guns, most gun owners store their guns in unlocked areas of the home accessible to others dwelling there. As such, guns provide a danger to children or adolescents whose curiosity may lead them to find and play with a gun. Additionally, a child finding a firearm may take it to show friends or take it to school. While adults may believe that guns are safely put away, children and adolescents always seem to find them, and as a result, fatalities and injuries resulting from the accidental discharge of firearms, particularly by children, has become problematic. Also the intentional use of guns by children against classmates and teachers in schools has been increasing over the last several years. Suicides by use of firearms are also at an alarming rate. In response to the rise of this danger, the US Congress and many state legislative bodies throughout the country have enacted or are in the process of enacting legislation requiring that each new purchase or transfer of a gun be accompanied by the purchase or transfer of a suitable lock.

Most conventional gun locks are made of an easily manufactured material such as die cast aluminum or plastic to make the locks economically feasible for the gun manufacturers to bundle with each gun or the gun owner to purchase separately. Such material is subject to being compromised, for example, by forced removal of the lock by a prying and/or sawing attack.

This latter problem came to a head early in 2001 when the California legislature, aware that there were many inadequate gun locks on the market, passed legislation which will make it unlawful for a firearm to be sold or transferred within the State of California after Jan. 1, 2002 without an approved safety device. In implementing the legislation the California Department of Justice, Firearm Division, has required that among other things any approved lock resist destruction of the lock.

Gun locks are typically classified into two categories, i.e., trigger locks and cable locks. Trigger locks such as those disclosed in U.S. Pat. Nos. 5,437,119 and 5,918,402 and application Ser. Nos. 09/593,533, 09/871,753 and 10/029,689, assigned to the assignee of this application, have two sides which clamp around the trigger guard of a gun to prevent access to the trigger. While trigger locks, if properly constructed, function as satisfactory determents to the unauthorized use of a firearm, such locks have a drawback of not insuring that a bullet is not present in the chamber of the locked gun. In addition, trigger locks are generally more expensive than cable locks.

A typical gun cable lock includes an elongated flexible cable which is generally armored, i.e., the individual sockets or links (not shown) are joined together by a twisted wire with the links being made of hardened steel to deter access to the inner wire. The flexible cable is shown in FIG. 1 as being threaded through the barrel 12 of a handgun 14. The fixed end 10a of the cable is secured within a lock housing 16 by means of a sheave 16b wedged within a groove 10b in the fixed end. See FIGS. 2-4. The lock housing is formed from a plurality of steel laminations 16c secured together via rivets 16d and includes a cable free end receiving bore 16e within which is positioned a plunger member 18 biased upwardly by compression spring 20. See FIG. 2. A plastic cover 22 encompasses the sides and a portion of the top and bottom of the housing.

A conventional key cylinder lock 28, mounted in the lock housing, includes a spring biased split tumbler casing 28a and a plug or inner barrel 28b which is rotatable, through a given angle, 90° or less, with a key 29. The plug 28b is formed with two upwardly projecting spaced posts 28c positioned on the underside 30a of a cam 30 which includes downwardly projecting triangular-shaped stops 30b. Only one of the posts is shown in FIGS. 2-4. The stops 30b are engaged by the posts 28c to rotate the cam to its unlocked position by action of the key 29 as will be explained. An upstanding rib 30c and a short spring retaining rod 30d are formed on the upper surface 30e of the cam. See FIGS. 7 and 8. A spiral spring 32 extends between a center in the rod 30d and a stationary notch 16f in one of the laminated plates, to bias the cam in a counterclockwise direction viewing the top surface of the cam as is illustrated in FIG. 7. The cam and bias spring are sometimes referred to as a spring/cam assembly herein.

A locking member or bar 34 rides on the upper surface 30e of the cam and is biased toward the bore 16e but prevented from entering the bore by the spring biased plug 18 unless the free end of the cable has depressed the plunger and placed an annular groove 10c at the cable free or active end 10d opposite the locking member 34. In this case, the locking member is pushed by the rib 30c into the groove via the action of spring 32 to lock the cable free end 10d to the housing.

The prior cable lock housings, designed to deter a cutting or sawing attack, employ hardened steel laminations with non-hardened rivets to secure the laminations together. While the laminations are stamped out and partially assembled by automatic machines there is still some hand labor involved in inserting the key lock cylinder, cam, locking bar, sheave and plunger/spring components (if used) during the assembly process. In total about 20 laminations, 4 rivets, a key cylinder, a locking bar and a cam (assuming that the plunger/spring is not used) are needed for each lock housing.

There is a need for a simpler, less expensive and lighter lock housing for cable locks designed to meet anti-strict testing criteria now in place in at least one state and under consideration at the Federal Government.

### SUMMARY OF THE INVENTION

In accordance with the present invention an elongated cable, preferably armored, or alternatively a shackle, is provided with a free end. The free end of the cable is adapted to be inserted through a barrel, cartridge ejection port or magazine chamber of a firearm and a fixed end which is not insertable through such firearm. The shackle is adapted to be inserted through a hasp, for example. The free end defines an annular groove or detent.

A lock housing, formed of an inner substantially rigid non-steel body encapsulated or enclosed within a hardened steel shell, has a top and bottom wall and a cable (or shackle) free end receiving bore defining a longitudinal axis extending from the top wall and capturing the fixed end of the cable. The rigid inner body, having a hardness value less than steel, shell may, for example, be made of plastic. The housing further includes a lock cylinder cavity extending into the housing from the bottom wall and also oriented parallel to the longitudinal axis, the housing having a key access opening into the cavity.

A key lock cylinder is mounted in the cavity and includes a rotatable plug for receiving and turning through a predetermined angle from a locked to an unlocked position with a key. A locking member or deadbolt is coupled to the cylinder and arranged for movement out of the cable (or shackle) free end receiving bore when operated by the key to enable the cable or shackle free end to be removed from the housing. Preferably the deadbolt or locking member moves into and out of the cable free end receiving bore only in response to the rotation of the plug to the locked (first) and unlocked (second) positions, respectively.

The construction and operation of the invention can best be understood by reference to the following description taken in conjunction with the accompanying drawings wherein like components are given the same reference numeral in the several figures.

### BRIEF DESCRIPTION OF THE DRAWINGS

FIG. 1 is a diagrammatic view of a cable gun lock in use to deny authorized access to the firearm;

FIG. 2 is a side elevational view of a prior art cable lock with the free or active end of the cable located outside of a lock housing with the housing shown in a cross-sectional view;

FIG. 3 is a cross-sectional view of the gun lock housing of FIG. 2 with the free end of the cable locked inside the housing;

FIG. 4 is a cross-sectional view of the gun lock housing of FIG. 3 showing the free end of the cable inserted part way into the housing;

FIG. 5 is a cutaway view of the housing taken along lines 5-5 of FIG. 3 showing the position of a locking member and cam in the locked position;

FIG. 6 is a bottom view of the cam of FIG. 5;

FIG. 7 is a top view of the cam of FIG. 5 in the locked position;

FIG. 8 is a top view of the cam in the unlocked position;

FIG. 9 is a top plan view of a spiral spring for biasing the cam and locking member towards the locked position;

FIG. 10 is a side elevation cross-sectional view of a cable and gun lock housing in accordance with the present invention with the cable free endlocked in the lock housing;

FIG. 11 is an exploded unassembled view of the lock housing of FIG. 10, without the key and with the inner body component shown in cross-section;

FIG. 12 is a perspective view of the assembled lock housing;

FIG. 13 is a cross-sectional view taken along lines 13 of FIG. 12 showing the cam or deadbolt in a locked position;

FIG. 14 is a cross-sectional view taken along line 13-13 showing the deadbolt in an unlocked position;

FIG. 15 is a top plan view of the deadbolt;

FIG. 16 is a bottom view of the lock housing;

FIG. 17 is a cross-sectional view of an alternative embodiment of the invention in which the free or second end of the cable is secured to an enlarged member for preventing the movement of such end through a gun barrel or cartridge ejection chamber;

FIG. 18 is a cross-sectional view of a conventional type shackle padlock utilizing the present invention; and

FIG. 19 is a cross-sectional view of the lock taken along lines 19-19 of FIG. 18.

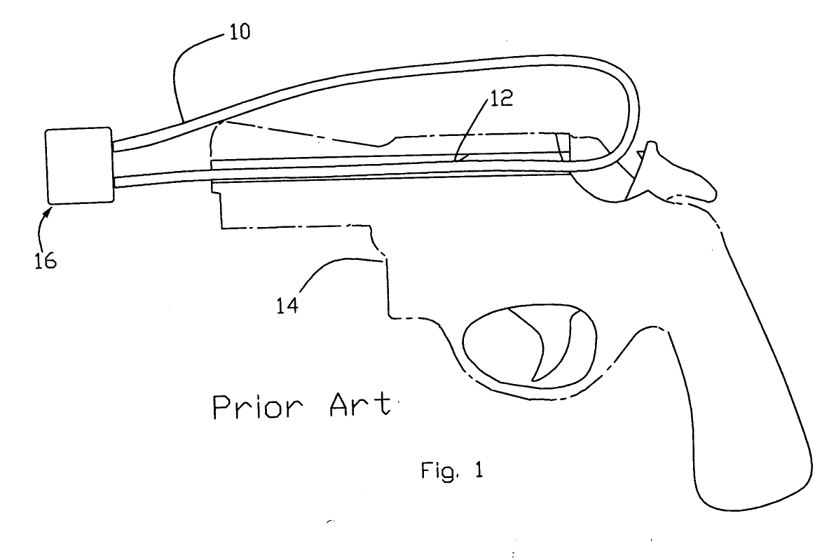

### DESCRIPTION OF THE PREFERRED EMBODIMENT

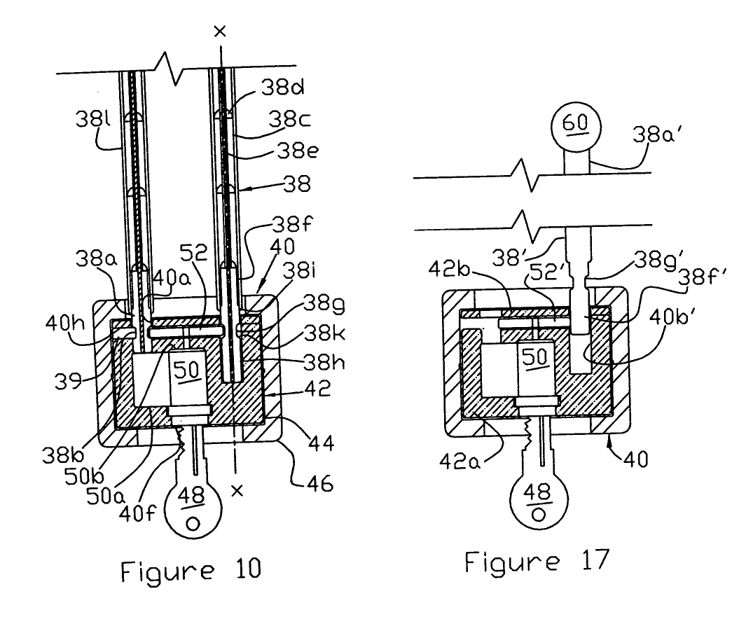

Referring now to the drawings and particularly to FIG. 10 the fixed end 38a of an articulated cable (preferably armored) is secured within a opening 40a of a lock housing 40 by means of a sheave 39 wedged into a groove 38b.

The cable is formed by metal sleeves or links 38c made, for example, of hardened steel and formed with a convex portion 38d at one end which extends into the adjacent link to provide the articulation necessary to allow the cable to be threaded through a gun barrel, cartridge ejection chamber or magazine chamber (hereinafter collectively referred to as the “barrel”). A central twisted wire 38e extends through the links and is crimped to the fixed end and also to a free or active end 38f to join the links together. The free or active end of the cable defines an annular groove 38g formed by a reduced diameter section bounded by a lower section 38h and an upper section 38i. The junction between the reduced section and lower section 38h forms a shoulder 38k which functions in conjunction with a rotatable or pivotal cam or deadbolt 52 to lock the cable free end in the housing as will be explained.

A plastic sleeve or coating 381 encloses the links to prevent marring of a gun barrel, etc. The diameter of the cable is preferably small enough to be threaded through the barrel of one of the smaller guns such as a 22 caliber. A diameter of about 0.215 inches has been found to be satisfactory for this purpose.

The lock housing 40 is formed of an inner substantially rigid non-steel, e.g., plastic, body 42 encapsulated within a saw-resistant shell 44 as will be explained in more detail with respect to FIGS. 11-13. The lock housing includes a first blind bore 40b (FIG. 16), which defines a longitudinal axis x-x, for receiving the cable free end and a second blind bore 40a, parallel to bore 40b for receiving the fixed end of the cable. A rubber boot 46 is fitted around the sides 40c, the top wall 40d and bottom wall 40e (FIG. 12) of the housing leaving the cable openings 40a and 40b and an access opening 40f for a key 48.

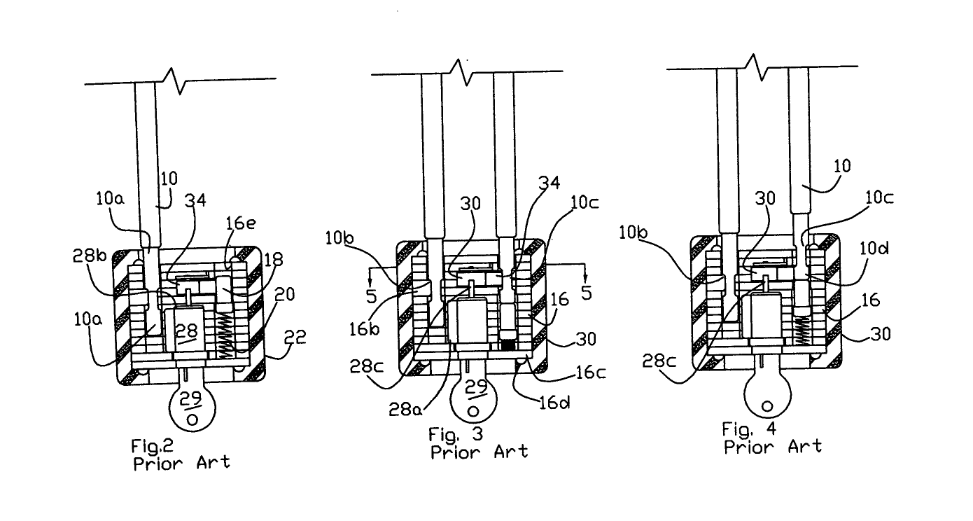

A conventional key lock cylinder 50 is mounted in a housing cavity 40g, which cavity is aligned along an axis parallel to the axis x-x. A split tumbler casing 50a functions with the key 48 to allow an inner barrel or plug 50b of the key cylinder to rotate through about a given angle, i.e., 90° or less, from a first position which may (but need not be) the locked position (FIG. 13) to a second unlocked position (FIG. 14). It is to be noted that the first position of the plug may merely allow the locking member to move into the cable free end groove under the force of a spring as is illustrated in FIGS. 2-4.

A pair of upwardly protruding posts 50c formed integrally with the plug, engage lock and unlock actuating shoulders 52a and 52b, respectively, formed by a Figure 8-shaped opening, in a deadbolt 52 as is illustrated in FIGS. 13 and 14. The deadbolt, sometimes referred to as a locking member or cam, is preferably made of a metal such as steel. The deadbolt is planar in form and lies in a plane perpendicular to the longitudinal axis as illustrated. The deadbolt preferably terminates at one end in a protruding tip 52c (as shown in FIG. 15) which extends into and out of the cable free end receiving bore 40b when the plug is rotated to its locked and unlocked position, respectively. The other end of the deadbolt terminates in a tip 52d which is arranged to extend into the groove 38b in the locked position (FIG. 10) to function along with the sheave 39 to maintain the fixed end of the cable within the lock housing. It is to be noted that the extension of the deadbolt tip 52d into the groove in the fixed cable end is optional.

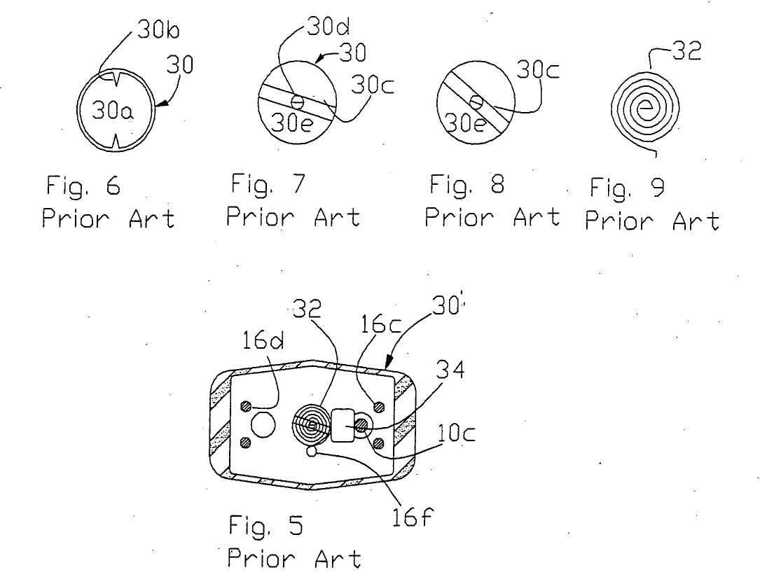

It should be noted that the locking member may be in the form of a ball, plate or bar such as item 34 in FIG. 2. A cam such as item 30 in FIG. 2 and bias spring, item 32 (FIG. 5) may be used to force the locking member into the cable free end groove as is illustrated in FIGS. 2-8. With this arrangement rotation of the plug to the unlocked position allows the locking member to be moved out of the cable receiving bore so that the free end of the cable may be removed from the housing.

While the plug 50b rotates through an angle of about 45° between the unlocked (FIG. 14) and locked (FIG. 13) positions the cam rotates through a smaller angle of about 20°. This action accommodates the relatively narrow width of the lock housing.

The key lock cylinder is preferably arranged so that the key can only be inserted and withdrawn when the plug is in the locked position, i.e., with the cam tips extending into the cable receiving bores. This ensures that the key cannot be withdrawn with the cable free end only partially inserted into the bore 40b as is illustrated in FIG. 10. The cable free end must be inserted fully, i.e., a predetermined distance, into the bore 40b before the key 48 can be removed from the lock. This arrangement greatly reduces the possibility that a user will mistakenly believe that the cable is secured to the lock housing.

Referring again to FIGS. 11-13 the housing shell 44 comprises two generally rectangular cup-shaped sections, i.e., lower and upper sections 44b and 44a, respectfully. The upper section 44a defines the entrance to the fixed and free end cable receiving bores 40a and 40b. In addition, the lower casing defines a key access opening 40g which allows the entry of the key 48 into the lock cylinder 50, but extends over the lock shear line to deter one from drilling out the lock. See FIG. 16. The body 42, when made of plastic, is preferably molded, by the injection process, from a suitable substantially rigid and preferably light weight material, such as ABS having a hardness less than steel. The body 42 includes a lower body section 42a and an upper plate-like section 42b. A suitable fiber filler may be added to the plastic for added strength.

In the assembly process the cylinder lock is inserted into the lower body section 42a. The deadbolt or cam 52 is then inserted into the lower body section 42a with the central opening 52e therein extending over the plug posts 50c as is illustrated in FIGS. 13 and 14. The upper body plate section 42b is then placed over the deadbolt plate to complete the inner assembly process. The upper and lower shell sections 44a and 44b are inserted over the body 42 with an outwardly extending flange 44c on the upper section fitted over bead 44d on the lower section to form a seam line 44d perpendicular to the longitudinal axis as shown. The upper and low shell sections are secured along the seam line by suitable means such as spot welding at locations 44e. The upper shell section 44a is formed with an opening 44f which coincides with a slot 42c in the plastic body in the assembled condition to receive the sheave 39 to lock the fixed end of the cable in the housing. The rubber boot is molded over the housing leaving openings 40a and 40b and an opening providing access to the bottom of the key lock cylinder. The cable fixed end can be secured in the bore 40a via the sheave 39 before or after molding the rubber boot onto the housing. The shell 44 is preferably made of hardened steel and have a Rockwell C shore hardness of about 30 or greater and most preferably about 40 or greater. A Rockwell C hardness of about 60 has been found to provide considerable saw and cutting resistant protection. The shell thickness may be within the range of about 0.010 to 0.100 inches and is preferably within the range of about 0.020 to 0.060 inches. A thickness of about 0.040 inches has been found to be quite satisfactory.

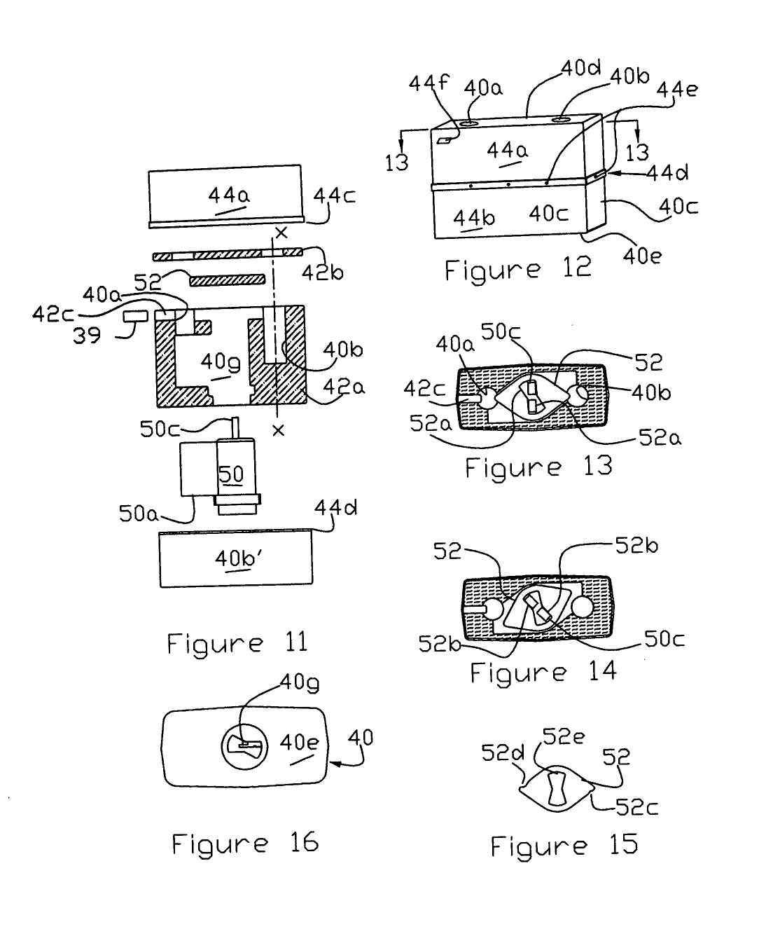

Referring now to FIG. 17 a lock assembly is shown in which a cable 38′ includes a free end 38f insertable into bore 40b′ and secured therein (in the locked position) by arm 52′ which extends into groove 38g′. The lock is illustrated in FIG. 17 in its unlocked condition. The cable fixed or second end 38a′ comprises an enlarged member 60, for example, in the form of a metal ball, to preclude the second end from passing through a gun barrel or cartridge ejection chamber. The upper section 44b of the shell 44 need be provided with only one cable receiving bore. Except for such differences, the lock assembly of FIG. 17 functions in the same manner as the lock assembly of FIGS. 10-15.

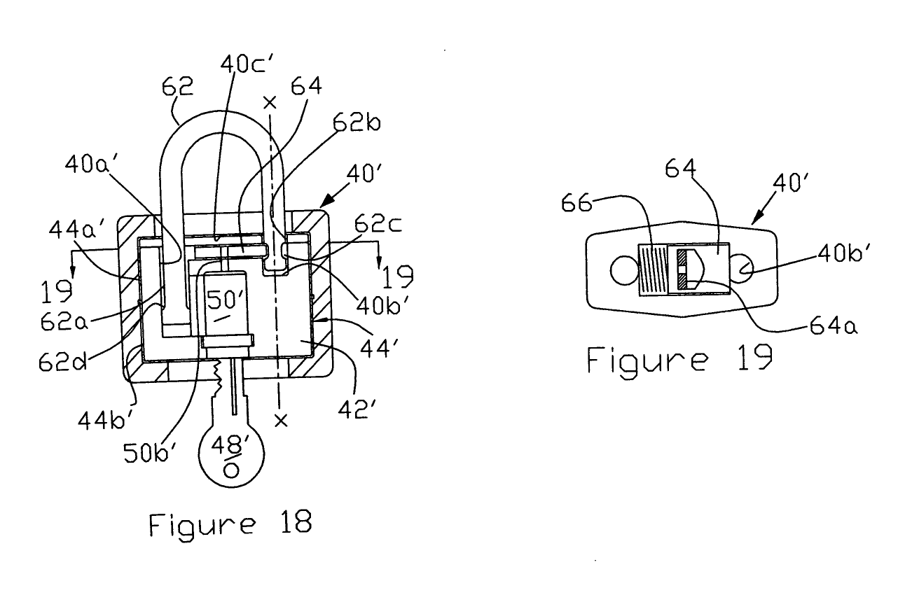

Referring now to FIGS. 18 and 19, there is shown a conventional type shackle padlock in which the lock housing 40′ is formed of an inner plastic body 42′ encapsulated within a metal shell 44′, preferably made of hardened steel and including upper and lower sections 44a′ and 44b′ welded or otherwise secured together, as discussed with respect to FIG. 10, etc. The first and second blind bores 40a′ and 40b′, respectively, receive the fixed end 62a and the free end 62b of a swivel shackle 62. The bore 40b′ defines the longitudinal axis x-x. The housing includes a cavity for the cylinder lock 50′ as illustrated. A plate or locking member 64 is biased by a compression spring 66 into the bore 40b′ to engage a groove or indent 62c in the free end of the shackle and maintain it in a locked position. A key 48′, when rotated clockwise or counterclockwise, causes the rotatable plug 50b′ to engage a shoulder 64a on the plate (or cam) 64 and force it against the spring and out of the groove 62c to unlock the padlock. A shoulder 62d on the bottom of the shackle fixed end and the narrow opening 40c′ in the upper shell section retain that end in the lock housing in a conventional manner.

The lock housing for releasably securing a cable to a firearm to deter the unauthorized use thereof or for releasably securing the free end of a shackle in a conventional shackle type padlock is simple, reliable and relatively inexpensive to manufacture. The housing comprises as few as six parts as compared with conventional laminated lock housings which comprises as many as twenty-five (25) or more separate parts. The savings in manufacturing material and labor is estimated to be about 25% or more. In addition, with a plastic body, there is a considerable saving in weight, e.g., 4.4 ounces versus 7+ ounces which can make a difference in freight costs when shipped separate or with a firearm.

Various modifications of the lock housing will undoubtedly occur to those skilled in the art without involve a departure from the spirit and scope of the present invention as called for in the appended claims.

1. A lock assembly for securing firearms against unauthorized access comprising:
an elongated flexible cable having a free end adapted to be inserted into a barrel or chamber of a firearm and a second end which is not insertable through the barrel or chamber, the free end defining an annular groove;
a lock housing formed of an inner substantially rigid non-steel body encapsulated within a saw resistant shell, the shell being formed of hardened steel having a Rockwell hardness of about 30 or greater, the housing having a top and bottom wall and forming a cable receiving bore extending into the housing from the top wall along a longitudinal axis, a key lock cylinder cavity oriented parallel to the longitudinal axis and having a key access opening in the bottom wall;
a key lock cylinder mounted in the cavity and having a rotatable plug for receiving and turning through a predetermined angle from a first position to an unlocked position with a key; and
a locking member coupled to the cylinder plug and arranged for insertion into the cable free end annular groove to lock the free end into the housing, the cable free end being free to be removed from the housing in response to the rotation of the plug to the unlocked position.

2. The lock assembly of claim 1 wherein the shell comprises two cup-shaped sections, each section having a peripheral edge, the edges being secured together.

3. The lock assembly of claim 1 wherein the locking member is biased into the cable free end receiving bore and into the annular groove in the cable free end when inserted a predetermined distance into the bore.

4. The lock assembly of claim 1 wherein the first position of the rotatable plug is the locked position with the locking member inserted into the cable free end groove when the plug is in the locked position.

5. The lock assembly of claim 1 wherein the shell has a Rockwell C hardness of about 50 or greater.

6. The lock assembly of claim 1 wherein the shell has a thickness within the range of 0.020 to 0.100 inches.

7. The lock assembly of claim 1 wherein the plastic body is formed of ABS plus a fiber filler.

8. The lock assembly of claim 1 wherein the annular groove is defined by upper and lower cylindrical sections of substantially one diameter separated by an intermediate section of a reduced cross-sectional dimension so that the locking member extends into the intermediate section to secure the cable free end in the housing and locked position.

9. The lock assembly of claim 8 wherein the locking member is arranged to move laterally at a substantially right angle to the longitudinal axis.

10. The lock assembly of claim 9 wherein the lock cylinder is arranged so that the key is removable only when the plug is turned to the locked position.

11. The lock assembly of claim 10 wherein the lower section of the cable free end interferes with the movement of the locking member into the cable receiving bore when the cable free end is inserted into the bore a distance less than the predetermined distance to prevent removal of the key.

12. The lock assembly of claim 9 wherein the second end of the cable is secured to the lock housing.

13. In a padlock housing for releasably securing a free end of a shackle, the shackle having an indent on the free end thereof, the housing comprising:
an inner substantially rigid body encapsulated within a saw resistant metal shell, the shell being formed of hardened steel having a Rockwell C hardness of about 30 or greater and the body being formed of a material having a hardness value less than that of hardened steel shell, the body and shell having a top and bottom wall, the body and shell forming a shackle free end receiving bore extending into the housing from the top wall along a longitudinal axis and a key lock cylinder cavity oriented parallel to the longitudinal axis and having a key access opening in the bottom wall;
a key lock cylinder mounted in the cavity and having a rotatable plug for receiving and turning through a predetermined angle from a first position to a second unlocked position with a key; and
a locking member coupled to the cylinder plug for insertion into the shackle indent to lock the shackle free end into the housing, the shackle free end being free to be removed from the housing in response to the rotation of the plug to the unlocked position.

14. The lock assembly padlock housing of claim 13 wherein the shell comprises two cup-shaped sections, each section having a peripheral edge, the edges being secured together.

15. The padlock housing of claim 13 wherein the shackle includes a second end and the housing forms a second bore aligned parallel to the longitudinal axis for receiving the second end of the shackle.

16. The padlock housing of claim 15 wherein the peripheral edge of the two cup-shaped shell sections are welded together.
